(19) United States
(12) Patent Application Publication
(10) Pub. No.: US 2026/0164313 A1
(43) Pub. Date: Jun. 11, 2026

(54) SYSTEM AND METHOD FOR ROAMING REPORTING AND CONTROL

(71) Applicant: Verizon Patent and Licensing Inc., Basking Ridge, NJ (US)

(72) Inventors: Ye Thomas Huang, San Ramon, CA (US); Robert Avanes, Roanoke, TX (US); Shanthala Kuravangi-Thammaiah, Keller, TX (US); Helen Osias Eglip, Sammamish, WA (US)

(21) Appl. No.: 18/971,386

(22) Filed: Dec. 6, 2024

(51) Int. Cl. H04W 36/00; H04W 60/04

(52) U.S. Cl. CPC H04W 36/0016; H04W 36/0061; H04W 60/04

(57) ABSTRACT

One or more computing devices, systems, and/or methods for roaming reporting and control are provided. In an example, a roaming event subscription for a first communication network is generated. User equipment on the first communication network is registered. A first roaming event is received responsive to the user equipment transferring to a first roaming communication network. Responsive to the first roaming event and based on the roaming event subscription, a first roaming event report is generated including a first network identifier associated with the first roaming communication network and a device identifier for the user equipment. First services of the first communication network provided to the user equipment are controlled based on the first roaming event report.

### BACKGROUND

A communication network, such as a wireless cellular network, supports a variety of different types of devices such as mobile phones, tablets, smart devices, and/or other user equipment (UE). Wireless communications services and portable devices that use such services continue to increase in popularity. The wireless networks and mobile devices support a wide array of voice and data communication functions. A key feature of such devices and the wireless networks is mobility, the ability of the user with the device to move freely from place to place and still operate the device to obtain wireless network services. The capability of a cellular network to manage the movement of User Equipment (UE) within the cellular network is referred to as mobility management.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication network, according to some embodiments.

FIG. 2 is a message flow diagram for roaming reporting and control, according to some embodiments.

FIG. 3 is a flow chart illustrating an example method for roaming reporting and control, according to some embodiments.

FIG. 4 is an illustration of a scenario involving various examples of transmission mediums that may be used to communicatively couple computers and clients.

FIG. 5 is an illustration of a scenario involving an example configuration of a computer that may utilize and/or implement at least a portion of the techniques presented herein.

FIG. 6 is an illustration of a scenario involving an example configuration of a client that may utilize and/or implement at least a portion of the techniques presented herein.

FIG. 7 is an illustration of a scenario featuring an example non-transitory machine readable medium in accordance with one or more of the provisions set forth herein.

FIG. 8 is an illustration of an example environment in which at least a portion of the techniques presented herein may be utilized and/or implemented.

FIG. 9 is an illustration of an example network that may utilize and/or implement at least a portion of the techniques presented herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

In some instances, user equipment may transfer from a home communication network associated with a primary service provider to a different communication network operated by an established roaming partner of the primary service provider. Typically, while the user equipment is roaming, the roaming communication network provides connectivity while the primary service provider continues to maintain services offered to the user equipment, such as financial services or other transactions. When a user associated with the user equipment is traveling, such as in an area with many service providers, the user equipment may subsequently transfer from the first roaming communication network to one or more other roaming communication networks without returning to the home communication network. According to existing communication standards, the primary service provider is only notified of the identity of the roaming communication network 106-1 to 106-N for a first transfer to one of the roaming communication networks and not subsequent transfers to other roaming communication networks. Certain geographic regions are more susceptible to fraud, such as banking fraud. Due to the lack of roaming notifications for transfers after the first roaming communication network, the primary service provider may not be aware of the increased fraud risk and is thus unable to implement additional security measures.

One or more computing devices, systems, and/or methods for roaming reporting and control are provided. In an example, a roaming event subscription for a first communication network is generated. User equipment on the first communication network is registered. A first roaming event is received responsive to the user equipment transferring to a first roaming communication network. Responsive to the first roaming event and based on the roaming event subscription, a first roaming event report is generated including a first network identifier associated with the first roaming communication network and a device identifier for the user equipment. First services of the first communication network provided to the user equipment are controlled based on the first roaming event report.

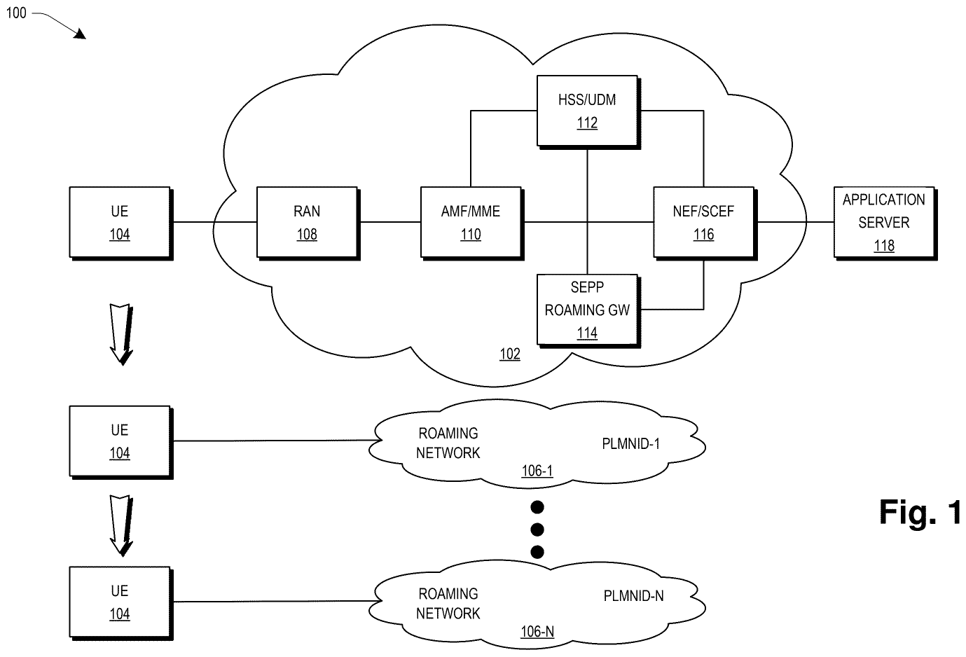

FIG. 1 is a diagram of a communication network 100, according to some embodiments. The communication network 100 comprises a primary communication network 102 for providing services to user equipment (UE) 104, such as a portable media player (e.g., an electronic text reader, an audio device, or a portable gaming, exercise, or navigation device); a portable communication device (e.g., a camera, a phone, a wearable, or a text chatting device); a workstation; and/or a laptop form factor computer. The UE 104 may transfer to one or more roaming communication networks 106-1 to 106-N that have roaming agreements with the service provider associated with the primary communication network 102. The roaming communication networks 106-1 to 106-N have associated public land mobile network identifiers (PLMNID-1 to PLMNID-N).

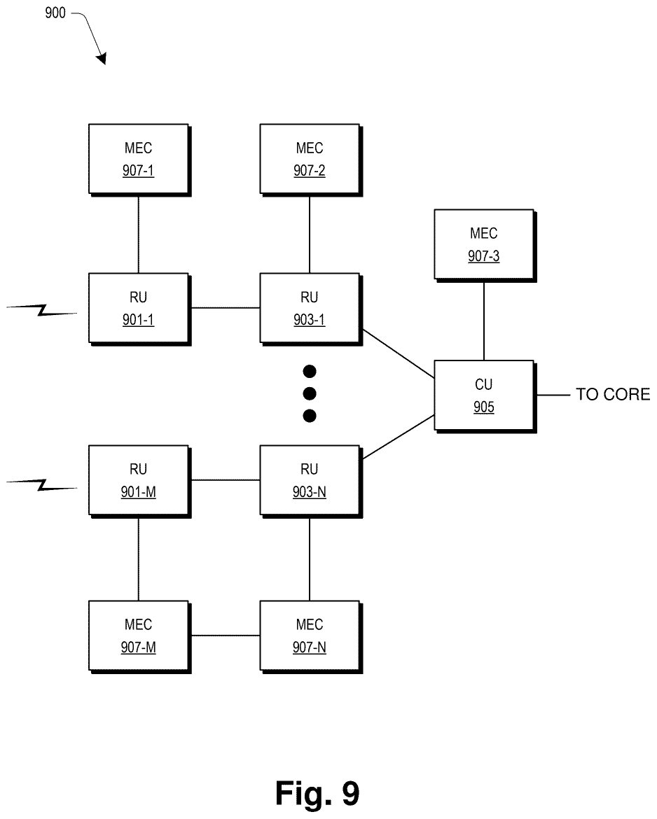

In some embodiments, the primary communication network 102 comprises a Radio Access Network (RAN) 108, a Mobility Management Entity (MME)/Access And Mobility Management Function (AMF) 110, a Home Subscriber Server (HSS)/Unified Data Management (UDM) 112, a Security Edge Protection Proxy (SEPP) Roaming Gateway (GW) 114, and a Network Exposure Function (NEF)/Service Capabilities Exposure Unit (SCEF) 116. The RAN 108 is the radio interface between the UE 104 and the primary communication network 102, the NEF/SCEF 116 is the interface with an application server 118, and the SEPP roaming GW 114 is the interface to provide end-to-end confidentiality and integrity with the roaming communication networks 106-1 to 106-N. The AFM/MME 110 provides mobility session management and supports subscriber authentication, roaming, and handovers to other networks. The HSS/UDM 112 stores and manages user-related and subscription-related information. The application server 118 delivers business applications, such as banking services, to the UE 104 through the primary communication network 102. A more detailed description of the primary communication network 102 is provided below in FIG. 9.

In some embodiments, the primary communication network 102 uses roaming filters to trigger events associated with the UE 104 roaming from the primary communication network 102 to one or more of the roaming communication networks 106-1 to 106-N. In some embodiments, a roaming filter may comprise a roaming enable filter (S-Filter) that specifies that roaming should be tracked or a target roaming network filter (P-Filter) that defines a target list of roaming communication networks 106-1 to 106-N for which additional actions may be taken for UE 104 transfers. For example, the roaming communication networks 106-1 to 106-N on the P-Filter target list may be more susceptible to security risks or fraud. If a transfer to a target roaming communication networks 106-1 to 106-N is identified, additional security measures may be taken, such as the application server 118 indicating that multiple level authentication should be implemented for requested transactions. An S-Filter or a P-Filter may be applied to a global scope (i.e., to all UE 104) or to a list of individual UE 104.

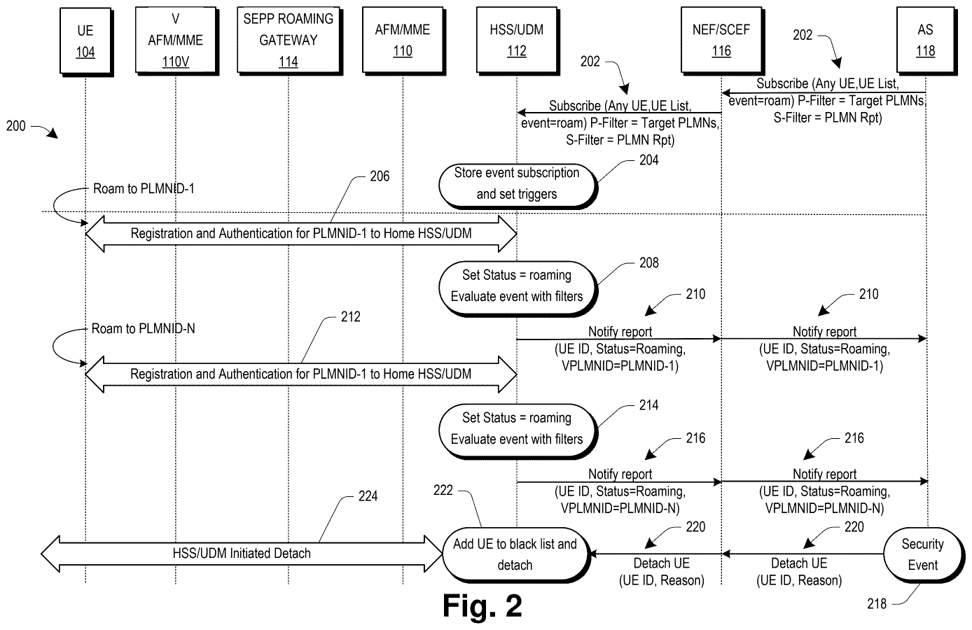

FIG. 2 is a message flow diagram 200 for roaming reporting and control, according to some embodiments. The application server 118 sends a roaming event subscription 202 to the NEF/SCEF 116:

Subscribe (Any UE, UE List, event=roam) P-Filter=Target PLMNIDs, S-Filter=PLMN Rpt),

where the roaming event subscription 202 defines the scope as all UE 104 (global) or a list of UE ID and the event (roam). In some embodiments, the roaming event subscription 202 includes a P-Filter including a list of Target PLMNIDs or and/or an S-Filter including a reporting flag (PLMN Rpt) that enables roaming reporting for all transfers if set or only for the first roaming transfer if not set. The NEF/SCEF 116 forwards the roaming event subscription 202 to the HSS/UDM 112, which stores the roaming event subscription and sets triggers at 204.

At 206, the UE 104 transfers from the primary communication network 102 to the roaming communication network 106-1 identified by PLMNID-1. The HSS/UDM 112 registers and authenticates the UE 104 to establish a link between the primary communication network 102 and the roaming communication network 106-1. The HSS/UDM 112 coordinates the transfer through the AFM/MME 110 and the SEPP roaming GW 114. The SEPP roaming GW 114 interfaces with the vendor AFM/MME 112V of the roaming communication network 106-1 to provide connectivity to the UE 104 on the roaming communication network 106-1. Services provided to the UE 104 are controlled by the application server 118 on the primary communication network 102 even after the transfer.

At 208, the HSS/UDM 112 sets the status for the UE 104 to “roaming” and evaluates the roaming event based on the roaming event subscription 202. For example, if the subscription has a global scope or the UE 104 is on the UE list and the S-Filter is set, the HSS/UDM 112 generates a roaming event report 210 indicating the roaming status and the VPLMNID (i.e., VPLMNID-1) of the roaming communication network 106-1 to the NEF/SCEF 116. The NEF/SCEF 116 forwards the roaming event report 210 to the application server 118. In some embodiments, even if UE 104 is on the UE list and the S-Filter is set, the HSS/UDM 112 suppresses the roaming event report 210 responsive to the VPLMNID not being in the P-Filter list of Target PLMNIDs.

At 212, the UE 104 transfers from the primary communication network 102 to a second roaming communication network 106-N identified by PLMNID-N. The HSS/UDM 112 registers and authenticates the UE 104 to establish a link between the primary communication network 102 and the roaming communication network 106-N. At 214, the HSS/UDM 112 sets the status for the UE 104 to “roaming” and evaluates the roaming event based on the roaming event subscription 202. For example, if the subscription has a global scope or the UE 104 is on the UE list and the S-Filter is set, the HSS/UDM 112 generates a roaming event report 216 indicating the roaming status and the VPLMNID (i.e., VPLMNID-1) of the roaming communication network 106-N to the NEF/SCEF 116. The NEF/SCEF 116 forwards the roaming event report 216 to the application server 118.

In some embodiments, the application server 118 controls the services offered to the UE 104 based on the PLMNID of the roaming communication network 106-1 to 106-N. For example, the application server 118 may provide services to the UE 104 by serving as an intermediary between the UEs 104 and an institution (e.g., financial institution, security institution, etc.). Based on the PLMNID of the roaming communication network 106-1 to roaming communication network 106-N the application server 118 may limit services provided to the UE 104 by not allowing certain transactions, may increase security requirements for the UE 104 by indicating to the institution that multiple level authentication should be used, or by disabling service to the UE 104 altogether. The control of the services offered to the UE 104 based on the PLMNID may depend on whether the PLMNID of the roaming communication network 106-1 to 106-N is specified in the P-Filter.

At 218, the application server 118 identifies a security event, such as based on the PLMNID, responsive to an authentication failure communicated by the institution, suspicious activity, or some other security issue. The application server 118 sends a detach report 220 to the NEF/SCEF 116 specifying the ID of the UE 104 and the detach reason. The NEF/SCEF 116 forwards the detach report 220 to the HSS/UDM 112. At 222, the HSS/UDM 112 adds the UE 104 to the black list and detaches the UE 104. Detaching the UE 104 may include different levels of restriction, such as complete disconnection from the roaming communication network 106-1 to 106-N and the primary communication network 102, disconnection of data services while maintaining voice services, or some other restriction.

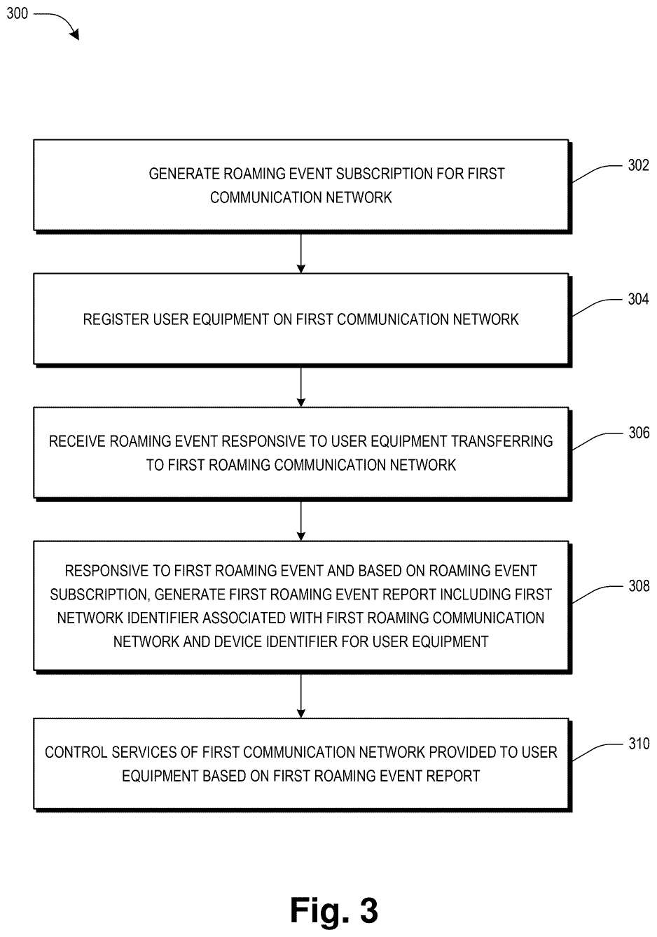

FIG. 3 is a flow chart illustrating an example method 300 for roaming coordination, according to some embodiments. At 302, a roaming event subscription 202 is generated for a first communication network 102. At 304, user equipment 104 is registered on the first communication network 102. At 306, a roaming event is received responsive to the user equipment 104 transferring to a first roaming communication network 106-1, 106-N. At 306, based on the roaming event subscription 202, a first roaming event report 210 including a first network identifier associated with the first roaming communication network 106-1, 106-N and a device identifier for the user equipment 104 is generated. At 308, services of the first communication network 102 provided to the user equipment 104 are controlled based on the roaming event report 210.

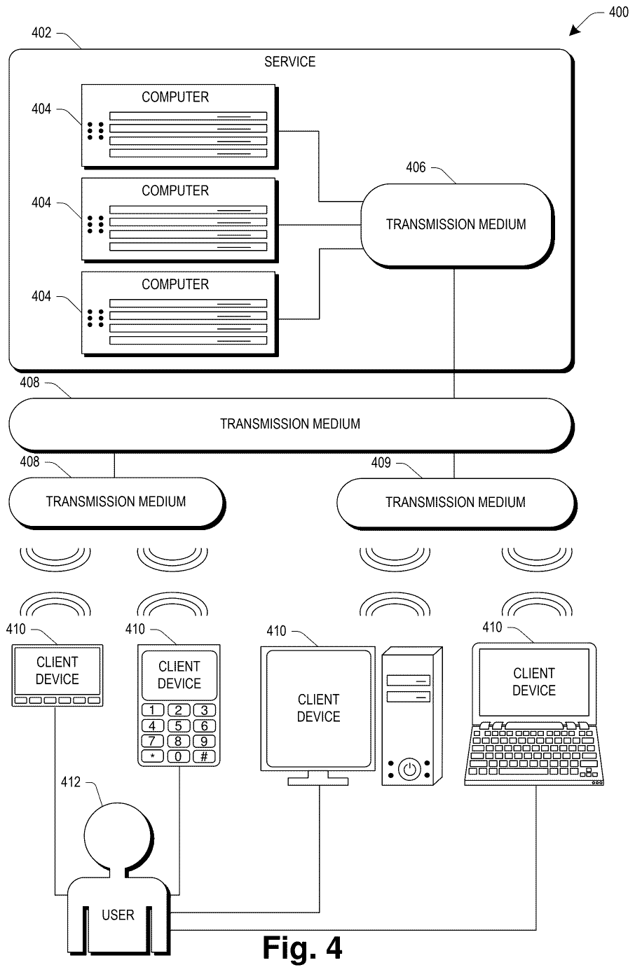

In some implementations, one or more process blocks of FIG. 3 may be performed by a device, a group of devices separate from or including the device, user equipment, and/or the like. FIG. 4 is an interaction diagram of a scenario 400 illustrating a service 402 provided by a set of computers 404 to a set of client devices 410 via various types of transmission mediums. The computers 404 and/or client devices 410 may be capable of transmitting, receiving, processing, and/or storing many types of signals, such as in memory as physical memory states.

The computers 404 of the service 402 may be communicatively coupled together, such as for exchange of communications using a transmission medium 406. The transmission medium 406 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 402.

Likewise, the transmission medium 406 may comprise one or more sub-networks, such as may employ different architectures, may be compliant or compatible with differing protocols and/or may interoperate within the transmission medium 406. Additionally, various types of transmission medium 406 may be interconnected (e.g., a router may provide a link between otherwise separate and independent transmission medium 406).

In scenario 400 of FIG. 4, the transmission medium 406 of the service 402 is connected to a transmission medium 408 that allows the service 402 to exchange data with other services 402 and/or client devices 410. The transmission medium 408 may encompass various combinations of devices with varying levels of distribution and exposure, such as a public wide-area network and/or a private network (e.g., a virtual private network (VPN) of a distributed enterprise).

In the scenario 400 of FIG. 4, the service 402 may be accessed via the transmission medium 408 by a user 412 of one or more client devices 410, such as a portable media player (e.g., an electronic text reader, an audio device, or a portable gaming, exercise, or navigation device); a portable communication device (e.g., a camera, a phone, a wearable, or a text chatting device); a workstation; and/or a laptop form factor computer. The respective client devices 410 may communicate with the service 402 via various communicative couplings to the transmission medium 408. As a first such example, one or more client devices 410 may comprise a cellular communicator and may communicate with the service 402 by connecting to the transmission medium 408 via a transmission medium 407 provided by a cellular provider. As a second such example, one or more client devices 410 may communicate with the service 402 by connecting to the transmission medium 408 via a transmission medium 409 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 404 and the client devices 410 may communicate over various types of transmission mediums.

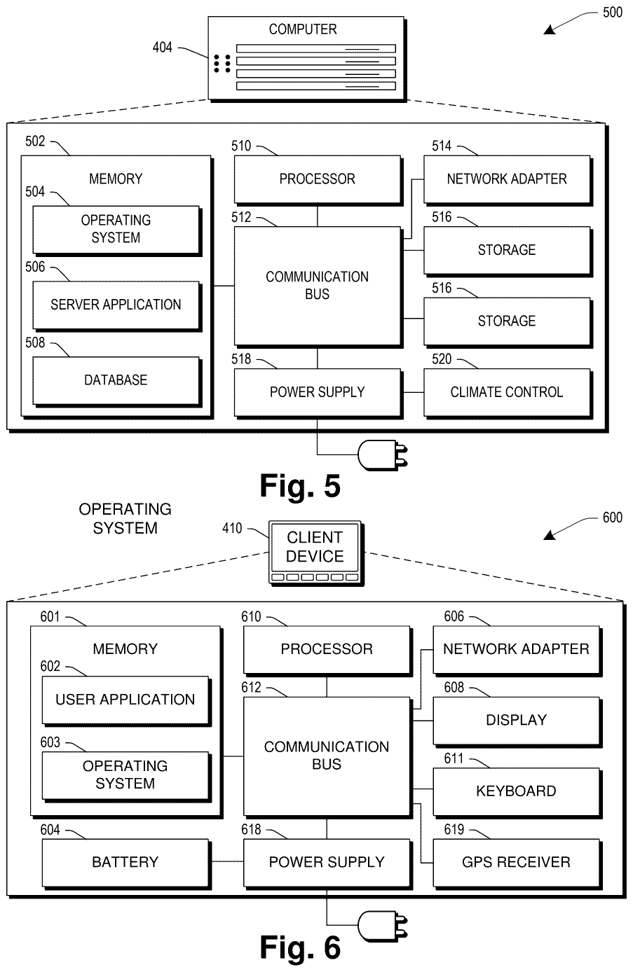

FIG. 5 presents a schematic architecture diagram 500 of a computer 404 that may utilize at least a portion of the techniques provided herein. Such a computer 404 may vary widely in configuration or capabilities, alone or in conjunction with other computers, in order to provide a service such as the service 402.

The computer 404 may comprise one or more processors 510 that process instructions. The one or more processors 510 may optionally include a plurality of cores; one or more coprocessors, such as a mathematics coprocessor or an integrated graphical processing unit (GPU); and/or one or more layers of local cache memory. The computer 504 may comprise memory 502 storing various forms of applications, such as an operating system 504; one or more computer applications 506; and/or various forms of data, such as a database 508 or a file system. The computer 404 may comprise a variety of peripheral components, such as a wired and/or wireless network adapter 514 connectible to a local area network and/or wide area network; one or more storage components 516, such as a hard disk drive, a solid-state storage device (SSD), a flash memory device, and/or a magnetic and/or optical disk reader.

The computer 404 may comprise a mainboard featuring one or more communication buses 512 that interconnect the processor 510, the memory 502, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 512 may interconnect the computer 504 with at least one other computer. Other components that may optionally be included with the computer 504 (though not shown in the schematic architecture diagram 500 of FIG. 5) include a display; a display adapter, such as a graphical processing unit (GPU); input peripherals, such as a keyboard and/or mouse; and a flash memory device that may store a basic input/output system (BIOS) routine that facilitates booting the computer 504 to a state of readiness.

The computer 404 may operate in various physical enclosures, such as a desktop or tower, and/or may be integrated with a display as an “all-in-one” device. The computer 404 may be mounted horizontally and/or in a cabinet or rack, and/or may simply comprise an interconnected set of components. The computer 404 may comprise a dedicated and/or shared power supply 518 that supplies and/or regulates power for the other components. The computer 404 may provide power to and/or receive power from another computer and/or other devices. The computer 404 may comprise a shared and/or dedicated climate control unit 520 that regulates climate properties, such as temperature, humidity, and/or airflow. Many such computers 404 may be configured and/or adapted to utilize at least a portion of the techniques presented herein.

FIG. 6 presents a schematic architecture diagram 600 of a client device 410 whereupon at least a portion of the techniques presented herein may be implemented. Such a client device 410 may vary widely in configuration or capabilities, in order to provide a variety of functionality to a user such as the user 412. The client device 410 may be provided in a variety of form factors, such as a desktop or tower workstation; an “all-in-one” device integrated with a display 608; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 410 may serve the user in a variety of roles, such as a workstation, kiosk, media player, gaming device, and/or appliance.

The client device 410 may comprise one or more processors 609 that process instructions. The one or more processors 609 may optionally include a plurality of cores; one or more coprocessors, such as a mathematics coprocessor or an integrated graphical processing unit (GPU); and/or one or more layers of local cache memory. The client device 410 may comprise memory 601 storing various forms of applications, such as an operating system 603; one or more user applications 602, such as document applications, media applications, file and/or data access applications, communication applications such as web browsers and/or email clients, utilities, and/or games; and/or drivers for various peripherals. The client device 410 may comprise a variety of peripheral components, such as a wired and/or wireless network adapter 606 connectible to a local area network and/or wide area network; one or more output components, such as a display 608 coupled with a display adapter (optionally including a graphical processing unit (GPU)), a sound adapter coupled with a speaker, and/or a printer; input devices for receiving input from the user, such as a keyboard 611, a mouse, a microphone, a camera, and/or a touch-sensitive component of the display 608; and/or environmental sensors, such as a global positioning system (GPS) receiver 619 that detects the location, velocity, and/or acceleration of the client device 410, a compass, accelerometer, and/or gyroscope that detects a physical orientation of the client device 410. Other components that may optionally be included with the client device 410 (though not shown in the schematic architecture diagram 600 of FIG. 6) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 410 to a state of readiness; and a climate control unit that regulates climate properties, such as temperature, humidity, and airflow.

The client device 410 may comprise a mainboard featuring one or more communication buses 612 that interconnect the processor 609, the memory 601, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 410 may comprise a dedicated and/or shared power supply 618 that supplies and/or regulates power for other components, and/or a battery 604 that stores power for use while the client device 410 is not connected to a power source via the power supply 618. The client device 410 may provide power to and/or receive power from other client devices.

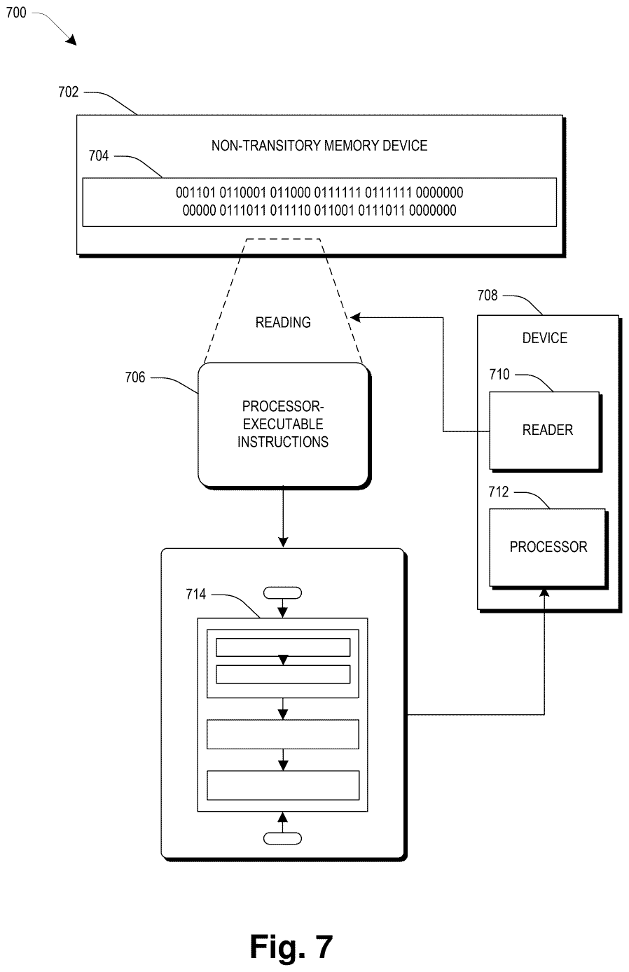

FIG. 7 is an illustration of a scenario 700 involving an example non-transitory machine-readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 702 stores machine-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system.

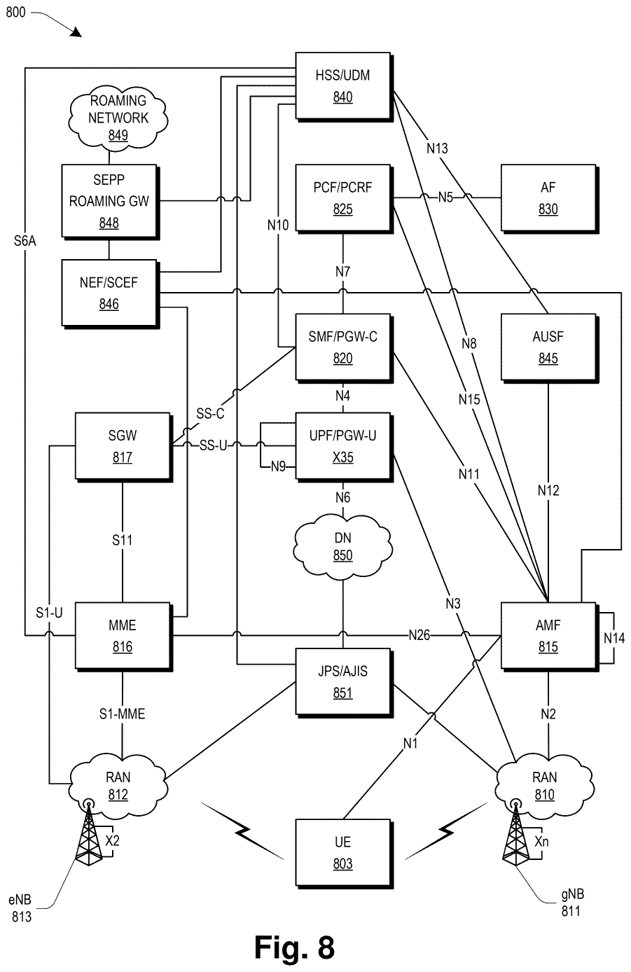

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 800 may include UE 803, RAN 810 (which may include one or more Next Generation Node Bs (“gNBs”) 811), RAN 812 (which may include one or more one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Home Subscriber Server (“HSS”)/Unified Data Management (“UDM”) 840, Authentication Server Function (“AUSF”) 845, Network Exposure Function (‘“ EF”)/Service Capabilities Exposure Unit (“SCEF”) 846, Security Edge Protection Proxy (“SEPP”) Roaming Gateway (“GW”) 848 (for interfacing with a roaming network 849. Environment 800 may also include one or more networks, such as Data Network (“DN”) 850. Environment 800 may include one or more additional devices or systems communicatively coupled to one or more networks (e.g., DN 850), such as client-side router 851.

The example shown in FIG. 8 illustrates one instance of each network component or function (e.g., one instance of SMF/PGW-C 820, PCF/PCRF 825, UPF/PGW-U 835, HSS/UDM 840, AUSF 845, NEF/SCEF 846, and/or SEPP Roaming GW 848). In practice, environment 800 may include multiple instances of such components or functions. For example, in some embodiments, environment 800 may include multiple “slices” of a core network, where each slice includes a discrete set of network functions (e.g., one slice may include a first instance of SMF/PGW-C 820, PCF/PCRF 825, UPF/PGW-U 835, HSS/UDM 840, AUSF 845, NEF/SCEF 846, and/or SEPP Roaming GW 848, while another slice may include a second instance of SMF/PGW-C 820, PCF/PCRF 825, UPF/PGW-U 835, HSS/UDM 840, AUSF 845, NEF/SCEF 846, and/or SEPP Roaming GW 848). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively and/or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 803 may include a computation and communication device, such as a wireless mobile communication device that is capable of communicating with RAN 810, RAN 812, and/or DN 850. UE 803 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 803 may send traffic to and/or receive traffic (e.g., user plane traffic) from DN 850 via RAN 810, RAN 812, and/or UPF/PGW-U 835.

RAN 810 may be, or may include, a 5G RAN that includes one or more base stations (e.g., one or more gNBs 811), via which UE 803 may communicate with one or more other elements of environment 800. UE 803 may communicate with RAN 810 via an air interface (e.g., as provided by gNB 811). For instance, RAN 810 may receive traffic (e.g., voice call traffic, data traffic, messaging traffic, signaling traffic, etc.) from UE 803 via the air interface, and may communicate the traffic to UPF/PGW-U 835, and/or one or more other devices or networks. Similarly, RAN 810 may receive traffic intended for UE 803 (e.g., from UPF/PGW-U 835, AMF 815, and/or one or more other devices or networks) and may communicate the traffic to UE 803 via the air interface.

RAN 812 may be, or may include, a LTE RAN that includes one or more base stations (e.g., one or more eNBs 813), via which UE 803 may communicate with one or more other elements of environment 800. UE 803 may communicate with RAN 812 via an air interface (e.g., as provided by eNB 813). For instance, RAN 810 may receive traffic (e.g., voice call traffic, data traffic, messaging traffic, signaling traffic, etc.) from UE 803 via the air interface, and may communicate the traffic to UPF/PGW-U 835, and/or one or more other devices or networks. Similarly, RAN 810 may receive traffic intended for UE 803 (e.g., from UPF/PGW-U 835, SGW 817, and/or one or more other devices or networks) and may communicate the traffic to UE 803 via the air interface.

AMF 815 may include one or more devices, systems, Virtualized Network Functions (“VNFs”), etc., that perform operations to register UE 803 with the 5G network, to establish bearer channels associated with a session with UE 803, to hand off UE 803 from the 5G network to another network, to hand off UE 803 from the other network to the 5G network, manage mobility of UE 803 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, etc., that perform operations to register UE 803 with the EPC, to establish bearer channels associated with a session with UE 803, to hand off UE 803 from the EPC to another network, to hand off UE 803 from another network to the EPC, manage mobility of UE 803 between RANs 812 and/or eNBs 813, and/or to perform other operations.

SGW 817 may include one or more devices, systems, VNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, etc., that gather, process, store, and/or provide information in a manner described herein. SMF/PGW-C 820 may, for example, facilitate in the establishment of communication sessions on behalf of UE 803. In some embodiments, the establishment of communications sessions may be performed in accordance with one or more policies provided by PCF/PCRF 825.

PCF/PCRF 825 may include one or more devices, systems, VNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, etc., that receive, store, and/or provide information that may be used in determining parameters (e.g., quality of service parameters, charging parameters, or the like) for certain applications.

UPF/PGW-U 835 may include one or more devices, systems, VNFs, etc., that receive, store, and/or provide data (e.g., user plane data). For example, UPF/PGW-U 835 may receive user plane data (e.g., voice call traffic, data traffic, etc.), destined for UE 803, from DN 850, and may forward the user plane data toward UE 803 (e.g., via RAN 810, SMF/PGW-C 820, and/or one or more other devices). In some embodiments, multiple UPFs 835 may be deployed (e.g., in different geographical locations), and the delivery of content to UE 803 may be coordinated via the N9 interface (e.g., as denoted in FIG. 8 by the line marked “N9” originating and terminating at UPF/PGW-U 835). Similarly, UPF/PGW-U 835 may receive traffic from UE 803 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

HSS/UDM 840 and AUSF 845 may include one or more devices, systems, VNFs, etc., that manage, update, and/or store, in one or more memory devices associated with AUSF 845 and/or HSS/UDM 840, profile information associated with a subscriber. AUSF 845 and/or HSS/UDM 840 may perform authentication, authorization, and/or accounting operations associated with the subscriber and/or a communication session with UE 803.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 803 may communicate, through DN 850, with data servers, other UEs UE 803, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 803 may communicate.

The client-side router 851 may include one or more devices, systems, VNFs, etc., that perform one or more operations described herein. For example, the client-side router 851 may monitor and/or analyze video stream chunks and/or statuses associated with video stream chunks to check for quality issues and/or may deliver video stream chunks to UE 803.

FIG. 9 illustrates an example Distributed Unit (“DU”) network 900, which may be included in and/or implemented by one or more RANs (e.g., RAN 810, RAN 812, or some other RAN). In some embodiments, a particular RAN may include one DU network 900. In some embodiments, a particular RAN may include multiple DU networks 900. In some embodiments, DU network 900 may correspond to a particular gNB 811 of a 5G RAN (e.g., RAN 810). In some embodiments, DU network 900 may correspond to multiple gNBs 811. In some embodiments, DU network 900 may correspond to one or more other types of base stations of one or more other types of RANs. As shown, DU network 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 10, such as AMF 815 and/or UPF/PGW-U 835). In the uplink direction (e.g., for traffic from UEs UE 803 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 803, and may determine which DU(s) 903 should receive the downlink traffic. DU 903 may include one or more devices that transmit traffic between a core network (e.g., via CU 905) and UE 803 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 803.

RU 901 may include hardware circuitry (e.g., one or more RF transceivers, antennas, radios, and/or other suitable hardware) to communicate wirelessly (e.g., via an RF interface) with one or more UEs UE 803, one or more other DUs 903 (e.g., via RUs 1001 associated with DUs 903), and/or any other suitable type of device. In the uplink direction, RU 901 may receive traffic from UE 803 and/or another DU 903 via the RF interface and may provide the traffic to DU 903. In the downlink direction, RU 901 may receive traffic from DU 903, and may provide the traffic to UE 803 and/or another DU 903.

RUs 901 may, in some embodiments, be communicatively coupled to one or more Multi-Access/Mobile Edge Computing (“MEC”) devices, referred to sometimes herein simply as (“MECs”) 907. For example, RU 901-1 may be communicatively coupled to MEC 907-1, RU 901-M may be communicatively coupled to MEC 907-M, DU 903-1 may be communicatively coupled to MEC 907-2, DU 903-N may be communicatively coupled to MEC 907-N, CU 905 may be communicatively coupled to MEC 907-3, and so on. MECs 907 may include hardware resources (e.g., configurable or provisionable hardware resources) that may be configured to provide services and/or otherwise process traffic to and/or from UE 803, via a respective RU 901.

For example, RU 901-1 may route some traffic, from UE 803, to MEC 907-1 instead of to a core network (e.g., via DU 903 and CU 905). MEC 907-1 may process the traffic, perform one or more computations based on the received traffic, and may provide traffic to UE 803 via RU 901-1. In this manner, ultra-low latency services may be provided to UE 803, as traffic does not need to traverse DU 903, CU 905, and an intervening backhaul network between DU network 900 and the core network. In some embodiments, MEC 907 may include, and/or may implement some or all of the functionality described above with respect to the client-side router 851.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
generating a roaming event subscription for a first communication network;
registering user equipment on the first communication network;
receiving a first roaming event responsive to the user equipment transferring to a first roaming communication network;
responsive to the first roaming event and based on the roaming event subscription, generating a first roaming event report including a first network identifier associated with the first roaming communication network and a device identifier for the user equipment; and
controlling first services of the first communication network provided to the user equipment based on the first roaming event report.

2. The method of claim 1, comprising:
receiving a second roaming event responsive to the user equipment transferring from the first roaming communication network to a second roaming communication network;
responsive to the second roaming event and based on the roaming event subscription, generating a second roaming event report including a second network identifier associated with the second roaming communication network and the device identifier; and
controlling second services of the first communication network provided to the user equipment based on the second roaming event report.

3. The method of claim 1, wherein:
generating the roaming event subscription comprises:
generating a target roaming communication network list; and
generating the first roaming event report, comprises:
generating the first roaming event report responsive to the first network identifier being on the target roaming communication network list.

4. The method of claim 1, comprising:
generating an event for the user equipment based on the first network identifier; and
detaching the user equipment from the first roaming communication network based on the event.

5. The method of claim 1, wherein:
controlling first services of the first communication network provided to the user equipment based on the first roaming event report comprises:
controlling authentication for transactions initiated by the user equipment.

6. The method of claim 1, wherein:
controlling first services of the first communication network provided to the user equipment based on the first roaming event report comprises:
restricting requested transactions initiated by the user equipment.

7. The method of claim 1, wherein:
generating a roaming event subscription comprises:
generating a roaming event subscription associated with an identifier of the user equipment.

8. The method of claim 1, wherein:
generating a roaming event subscription comprises:
setting a reporting flag to enable roaming reporting.

9. A first communication network for communicating with an application server, comprising:
a data management unit configured to:
register user equipment on the first communication network;
receive a first roaming event responsive to the user equipment transferring to a first roaming communication network;
send a first roaming event report to the application server including a first network identifier associated with the first roaming communication network and a device identifier for the user equipment;
receive a second roaming event responsive to the user equipment transferring from the first roaming communication network to a second roaming communication network; and
send a second roaming event report to the application server including a second network identifier associated with the second roaming communication network and the device identifier, wherein:
the application server is responsive to at least one of the first roaming event report or the second roaming event report and controls services provided to the user equipment.

10. The system of claim 9, wherein:
the data management unit is configured to:
receive an event subscription including a target roaming communication network list;
generate the first roaming event report responsive to the first network identifier being on the target roaming communication network list; and
suppress the second roaming event report responsive to the second network identifier not being on the target roaming communication network list.

11. The system of claim 9, wherein:
the data management unit is configured to:
receive an event for the user equipment generated based on the first network identifier; and
detach the user equipment from the first roaming communication network based on the event.

12. The system of claim 9, wherein:
the application server controls authentication for transactions initiated by the user equipment.

13. The system of claim 9, wherein:
the application server controls services provided to the user equipment by restricting requested transactions initiated by the user equipment.

14. The system of claim 9, wherein:
the data management unit is configured to:
receive a roaming event subscription associated with the device identifier of the user equipment; and
generate the first roaming event report based on the roaming event subscription.

15. The system of claim 14, wherein:
the roaming event subscription comprises a reporting flag to enable roaming reporting.

16. A non-transitory computer-readable medium, storing instructions thereon that when executed by a processor cause the processor to:
generate a roaming event subscription for a first communication network;
register user equipment on the first communication network;
receive a roaming event responsive to the user equipment transferring to a first roaming communication network;
responsive to the first roaming event and based on the roaming event subscription, generate a first roaming event report including a first network identifier associated with the first roaming communication network and a device identifier for the user equipment; and
control first services of the first communication network provided to the user equipment based on the first roaming event report.

17. The non-transitory computer-readable medium of claim 16, storing instructions thereon that when executed by the processor cause the processor to:
receive a second roaming event responsive to the user equipment transferring from the first roaming communication network to a second roaming communication network;
responsive to the second roaming event and based on the roaming event subscription, generate a second roaming event report including a second network identifier associated with the second roaming communication network and the device identifier; and
control services of the first communication network provided to the user equipment based on the second roaming event report.

18. The non-transitory computer-readable medium of claim 17, storing instructions thereon that when executed by the processor cause the processor to:
generate an event subscription including a target roaming communication network list;
generate the first roaming event report responsive to the first network identifier being on the target roaming communication network list; and
suppress the second roaming event report responsive to the second network identifier not being on the target roaming communication network list.

19. The non-transitory computer-readable medium of claim 16, storing instructions thereon that when executed by the processor cause the processor to:
generate a target roaming communication network list in the roaming event subscription; and
generate the first roaming event report responsive to the first network identifier being on the target roaming communication network list.

20. The non-transitory computer-readable medium of claim 16, storing instructions thereon that when executed by the processor cause the processor to:
generate an event for the user equipment based on the first network identifier; and
detach the user equipment from the first roaming communication network based on the event.
